(19) United States
(12) Patent Application Publication
(10) Pub. No.: US 2026/0168437 A1
(43) Pub. Date: Jun. 18, 2026

(54) INLET CONE FOR AN AIRCRAFT TURBINE ENGINE

(71) Applicant: SAFRAN AIRCRAFT ENGINES, Paris (FR)

(72) Inventors: Marion Michele PENVERNE, Moissy-Cramayel (FR); Jean-Marc Claude PERROLLAZ, Moissy-Cramayel (FR); Manuel Rui EVORA, Moissy-Cramayel (FR); Baptiste Rene Roger BATONNET, Moissy-Cramayel (FR)

(21) Appl. No.: 19/511,105

(22) PCT Filed: Aug. 14, 2024
(86) PCT No.: PCT/FR2024/051088

§ 371 Date: Feb. 13, 2026

(30) Foreign Application Priority Data
Aug. 24, 2023 (FR) FR2308908

(51) Int. Cl. F02C 7/06; F02C 3/04; F02C 7/047; F02C 7/32

(52) U.S. Cl. CPC F02C 7/06; F02C 3/04; F02C 7/047; F02C 7/32

(57) ABSTRACT

An inlet cone for an aircraft turbine engine is configured to be rotated about an axis (X). The inlet cone includes a frustoconical body and a tip made of elastically deformable material fixed to a smaller-diameter end of the body. The body includes through-housings distributed around the axis, and parts made of elastically deformable material located in the through-housings. Each of the parts made of elastically deformable material has at least one peripheral flange for retaining the part in the corresponding through-housing. The peripheral flange bears against an internal surface of the body.

### TECHNICAL FIELD OF THE INVENTION

The field of the present invention is that of the turbine engines, for example for aircraft. More particularly, the present invention relates to an air inlet cone for such aircraft turbine engines.

### TECHNICAL BACKGROUND

The prior art comprises the documents US-A1-2020/010172, WO-A1-2020/249888, FR-A1-3097200 and WO-A1-2022200733.

Turbine engines extending along a longitudinal axis and comprising, from upstream to downstream in the flow orientation of the gases, a fan, one or more compressor stages (e.g. a low-pressure compressor and a high-pressure compressor), a combustion chamber, one or more turbine stages (e.g. a high-pressure turbine and a low-pressure turbine), and a gas exhaust nozzle are known in the prior art.

Typically, such turbine engines also comprise, upstream, an air inlet cone which is mounted on the fan, for example by means of a generally annular shell itself connected to a low-pressure compressor shaft of the turbine engine. The connection between the inlet cone and the shell is generally made using bolted joints. The downstream end of the shell is flush with the platforms of the fan blade, in aerodynamic continuity with this one. Such an inlet cone comprises an upstream end in the form of a cone tip centred on an axis of rotation of the inlet cone, also corresponding to the longitudinal axis of the fan and the assembly of the turbine engine.

This tip is known to be a point on the turbine engine that favours ice accretion, as its centring on the axis of rotation does not allow significant centrifugal forces to be applied. As a result, if no special measures are taken, the ice that forms on the tip can grow to a large size before breaking off, with the risk, when it eventually comes loose from the tip, of damaging the fan blades that it hits or the aircraft engine that ingests it. The ice build-up can also accumulate unevenly on the tip, leading to undesirable vibrations in the turbine engine.

To overcome this problem, it has been proposed to install a de-icing system, the aim of which is to ensure that the ice accumulated on the tip is ejected before it reaches a critical size. However, this type of system is expensive in terms of mass and overall dimension, and particularly tricky to install because of the rotating nature of the inlet cone equipped.

It has also been proposed to remove the tip of the entrance cone to deal with these problems of ice accretion during operation. However, the absence of the tip does not allow the airflow entering the turbine engine during operation to be correctly deflected and guided, in particular to ensure its cooling and improve the air flow. Furthermore, a truncated inlet cone (i.e., without the tip) does not allow the inlet cone to be fully protected against ice formation and the ingestion of ice (or other solid particles) by the turbine engine during operation.

Finally, it is known in the prior art to produce, as shown in FIG. 1, an inlet cone 10 with an upstream tip 11 made of a flexible material (or in other words an elastically deformable material) and a downstream body 12 made of a rigid material. The tip 11 is generally glued to the downstream body 12. During operation, the layer of ice accumulated, particularly at the level of the connection where the tip meets the body, is weakened to encourage the ice to detach. However, this method of detaching the layer of ice, by weakening it and allowing cracks to propagate along it, may be slower than expected in the case of in-flight operation of the turbine engine. In fact, the larger the layer of ice, the slower and more difficult it is to form cracks in this layer. On the other hand, the generation of cracks directly between the portion of the cone made of flexible material and the accreted ice, particularly at low temperatures (i.e. between −30° C. and 15° C.), may not be sufficient since the adhesion of the ice to the cone is stronger than the force of detachment of the ice by centrifugal force. Such a solution is therefore not sufficient to quickly detach the layer of ice forming on the inlet cone into several small fragments without damaging the components of the turbine engine downstream of the cone.

In addition, it is also required that the flexible tip does not generally alter the aerodynamic performance or mechanical strength of the inlet cone (and therefore of the turbine engine). In particular, an offset and/or space can be generated at the bonding interface between the flexible material portion and the rigid material body. In operation, this could cause distortions (in particular without aerodynamic continuity) between the flexible material portion and the rigid material body, in which the ice could become brittle or enter the space. This could cause irreversible damage to the inlet cone. Thus, such a solution involving the assembly of a flexible portion and a body made of rigid material is not entirely satisfactory for limiting ice accretion on the inlet cone as much as possible.

In this context, it is interesting to propose a solution that allows to overcome the disadvantages of the prior art, in particular by introducing a new geometry for an air inlet cone that is more conducive to favour the controlled breakage of the ice during operation.

### SUMMARY OF THE INVENTION

The present invention thus proposes an inlet cone for an aircraft turbine engine, this inlet cone being configured to be driven in rotation about an axis X and comprising a body of frustoconical shape and a tip made of elastically deformable material fixed to an end of smaller diameter of said body, the body comprising through-housings distributed around the axis X and parts made of elastically deformable material located in said housings.

According to the invention, each of the parts made of elastically deformable material comprises at least one peripheral rim for retaining said part in the corresponding housing, said at least one peripheral rim bearing on an internal surface of said body.

This design of the present invention allows the size of ice accretion on the inlet cone of the turbine engine to be reduced during operation, thereby amplifying the ice de-accretion phenomenon.

To achieve this, the parts made of elastically deformable material each incorporate a peripheral rim that rests on the internal surface of the cone body. This peripheral rim enables the part made of elastically deformable material to be held firmly and effectively in the body of the cone (particularly in the corresponding through housing in the body). In particular, the parts made of elastically deformable material are held centrifugally by pressing the peripheral rims against the internal surface of the body of the cone.

In addition, the parts made of an elastically deformable material, such as elastomer, can deform and move radially (with respect to the axis X) when the cone is rotated and without these parts made of elastically deformable material becoming detached from the cone (thanks to the peripheral rims), and also continue to function at variations in external temperature (such as, for example, a low temperature of −30° C. to 15° C.). This contributes to the weakening of the layer of ice that has accumulated on the external surface of the cone. This embrittlement increases the frequency with which the ice breaks up, thereby reducing the size of the fragments of ice. Thus, the fragmentation and detachment of the ice is better controlled, so that the detached fragments of ice are of a size that is calibrated and acceptable for potentially being projected onto components downstream of the cone (such as the fan blades of the turbine engine) without damaging them.

The invention therefore has the advantage of being based on a simple design, offering very high reliability, with very low penalties in terms of cost, space requirements and environmental impact, particularly for aircraft turbine engine.

The inlet cone for the aircraft turbine engine according to the invention may comprise one or more of the following characteristics, taken in isolation from each other or in combination with each other:
each of the parts made of elastically deformable material comprises a single peripheral rim which extends around the entire periphery of the part in question;
each of the parts of elastically deformable material comprises a pad which occupies the entire volume of said through housing and which comprises an external surface aligned with an external surface of said body;
said pad is generally oblong, trapezoidal and/or rectangular in shape;
said pad extends over a length of between 50% and 90% of a total length of said corresponding part made of elastically deformable material, the lengths being measured substantially in a direction parallel to the external surface of the pad of the part in question;
said at least one peripheral rim has a thickness which is equal to the difference between a thickness of the pad and a thickness of the body, each of these thicknesses being measured in a direction perpendicular to the external surface of the part in question;
each elastically deformable part has a maximum thickness of between 2 mm and 3 mm, the thickness being measured in a direction perpendicular to the internal surface of the body;
the body also comprises a central orifice for the passage of a cylindrical portion of said tip;
said through housings and said parts made of elastically deformable material are three to ten in number, preferably said through housings and said parts made of elastically deformable material are six in number;
said through housings and said parts made of elastically deformable material are distributed in one or more annular rows, respectively, of through housings and parts made of elastically deformable material;
the tip is single part;
the body is made of a metallic or composite material;
said at least one peripheral rim rests directly on the internal surface of the body;
said at least one peripheral rim rests directly on the internal surface of the body without any adhesive, in particular between the peripheral flange and the internal surface of the body.

The invention also relates to an aircraft turbine engine comprising an inlet cone in accordance with one of the characteristics of the invention.

### BRIEF DESCRIPTION OF THE FIGURES

The invention will be better understood and other details, characteristics and advantages of the present invention will become clearer from the following description made by way of non-limiting example and with reference to the attached drawings, wherein:

FIG. 1 is a front perspective view schematically representing an inlet cone for an aircraft turbine engine, according to the prior art,

FIG. 2 is a schematic half-view of an aircraft turbine engine in axial section,

FIG. 3 is a front perspective view schematically representing an example of an inlet cone according to the invention, for the turbine engine of FIG. 2,

FIG. 4 is an axial cross-sectional view of the inlet cone shown in FIG. 3,

FIG. 5 is a rear perspective view showing schematically a tip of the inlet cone of FIG. 3 or 4,

FIG. 6 is a front perspective view showing schematically the tip and the parts made of elastically deformable material of the inlet cone of FIG. 3 or 4,

FIG. 7 is a front perspective view showing schematically a variant of the elastically deformable material parts of the inlet cone in FIG. 3 or 4.

The elements with the same functions in the different implementations have the same references in the figures.

### DETAILED DESCRIPTION OF THE INVENTION

By convention in the present application, the terms “inside” and “outside”, and “internal” and “external” are defined radially with respect to a longitudinal axis X in particular of the engine of the turbine engine. For example, a cylinder extending along the axis X comprises an inner surface facing the axis X and an outer surface opposite its inner surface. By “axial” or “axially” is meant any direction parallel to the axis X, and “transversely” or “transversal” is meant any direction perpendicular to the axis X. Similarly, the terms “upstream” and “downstream” are defined in relation to the flow orientation of the air in the turbine engine.

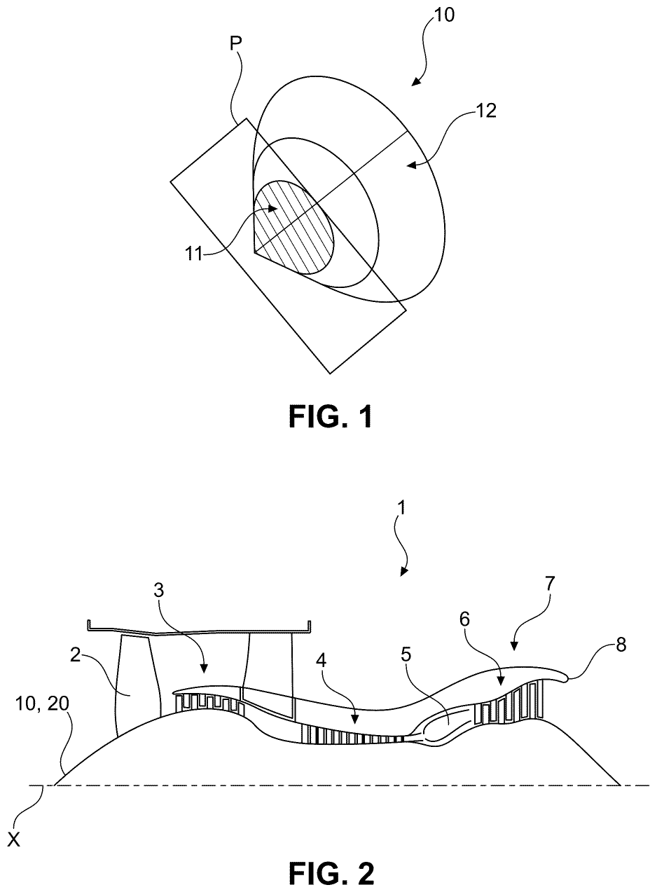

FIG. 1 has been described in the technical background of the present application, and illustrates an example of an inlet cone 10 according to the prior art for an aircraft turbine engine 1, which has an upstream tip 11 made of an elastically deformable material and a downstream body 12 made of a rigid material.

The present invention applies in a general and non-limiting manner to an aircraft turbine engine 1, illustrated for example in FIG. 2. The turbine engine 1 may be a turbojet, turboprop or turboshaft engine.

FIG. 2 shows a dual flow turbine engine 1. However, this is not a limit and the turbine engine may be of another type, such as a turboprop engine.

The turbine engine 1 can extend along a longitudinal axis X and comprises from upstream to downstream, in the direction of gas flow, a fan 2, one or more compressor stages (for example a low-pressure compressor 3 and a high-pressure compressor 4), a combustion chamber 5, one or more turbine stages (for example a high-pressure turbine 6 and a low-pressure turbine 7), and a gas exhaust nozzle 8. The fan 2, the low-pressure compressor 3 and the low-pressure turbine 7 are connected to a low-pressure shaft extending along the axis X. The high-pressure compressor 4 and the high-pressure turbine 6 are connected to a high-pressure shaft arranged around the low-pressure shaft. The low-pressure turbine 7 drives the low-pressure shaft in rotation, while the high-pressure turbine 6 drives the high-pressure shaft in rotation.

The turbine engine 1 comprises an air inlet cone 10, 20, in particular upstream of the fan 2. This cone can be mounted on the fan 2 by means of a shell (not shown), preferably by bolt-type fastenings. The shell is located downstream of the inlet cone and is also connected to the low-pressure shaft.

The inlet cone 10, 20 with the shell can be connected to the rotor, i.e. to the rotating portions of the turbine engine 1. The inlet cone 10, 20 is configured to be driven in rotation about a longitudinal axis that is substantially coincident with the axis X of the turbine engine 1.

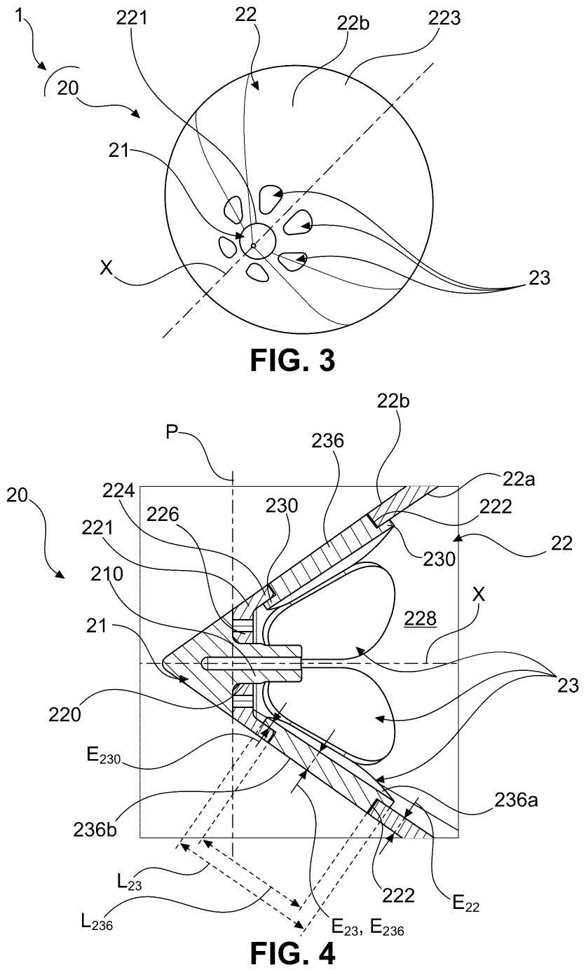

FIGS. 3 to 7 illustrate an example of the inlet cone 20 according to the invention.

With reference to FIGS. 3 and 4, the inlet cone 20 comprises a frustoconical body 22 and a tip 21 attached to a smaller diameter end 221 of the body 22.

The tip 21 is made of an elastically deformable material. The elastically deformable material of the tip 21 may be elastomer, silicone, rubber or polytetrafluoroethylene (PTFE).

With reference to FIGS. 3 to 5, the tip 21 is located upstream of the body 22. The tip 21 may comprise an apex through which the axis X passes. On the side opposite the apex, the tip 21 is fixed to the end 221 which may be disposed upstream (hereinafter referred to as the upstream end 221), for example substantially along a connecting plane P which is perpendicular to the axis X. To this end, the tip 21 may comprise a cylindrical portion 210. This cylindrical portion 210 may be located on the opposite side of the apex of the tip 21.

The cylindrical portion 210 can be mounted in a central orifice 220 in the body 22. To achieve this, the cylindrical portion 210 may have at least one threaded portion complementary to a thread in the central orifice 220. Alternatively, the cylindrical portion 210 can simply be fitted into the central orifice 220.

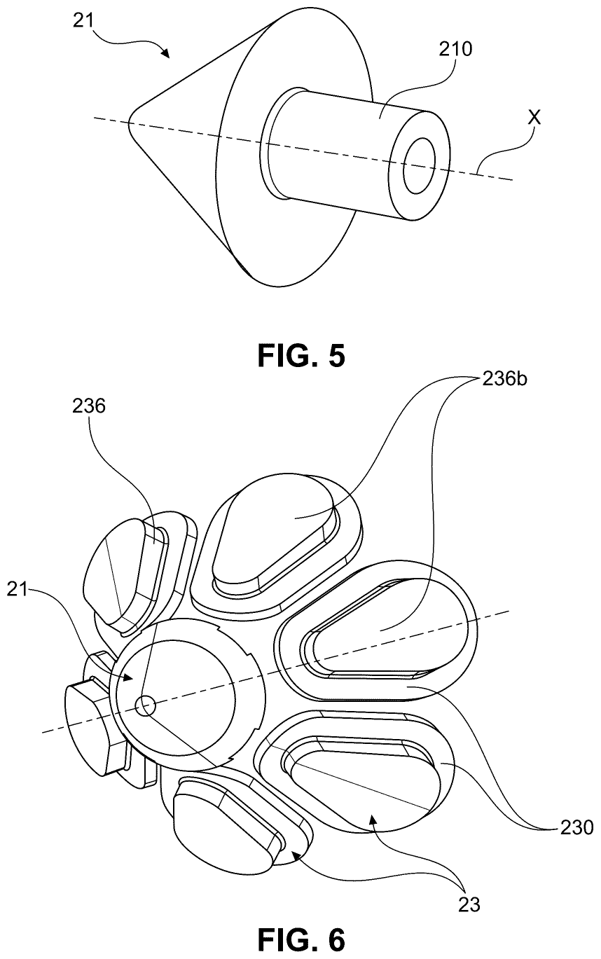

The tip 21 can be made in single part (i.e. from a single material). In particular, the tip 21 is formed in one part with the cylindrical portion 210, as shown in FIG. 5.

The body 22 can be made of a metallic material, such as aluminium or titanium, or of a composite material.

The body 22 may extend between the upstream end 221 and another end 223 located downstream (hereinafter referred to as the downstream end 223) and opposite the upstream end 221. This downstream end 223 can be configured to join with the shell of the fan 2 of the turbine engine 1.

The upstream end 221 may have a generally circular shape, preferably complementary to the tip 21 to ensure aerodynamic continuity. The body 22 can extend radially between an internal surface 22a and an external surface 22b opposite this internal surface 22a. The external surface 22b may be aerodynamically continuous (or otherwise aligned) with an external surface of the tip 21.

The body 22 may comprise a frustoconical wall 224 and a radial wall 226 (relative to the axis X), this radial wall 226 being connected to the frustoconical wall 224 upstream of the body 22, in particular at the upstream end 221. In the example shown in FIGS. 3 and 4, the frustoconical wall 224 and the radial wall 226 define a hollow portion 228 between them. This hollow portion 228 can at least partially receive the cylindrical portion 210 of the tip 21.

The body 22 may have a first thickness E₂₂ measured, for example, in a direction perpendicular to the internal surface 22a (or external surface 22b) of the body 22. In particular, this first thickness E₂₂ may correspond to that of the frustoconical wall 224 of the body 22.

The body 22 comprises through housings 222 which are distributed around the axis X. The through housings 222 may be apertures. The through housings 222 can be located on the frustoconical wall 224. The through housings 222 may be between three and ten in number. The through housings 222 can be arranged in one or more annular rows of through housings. Each through housing 222 may have a generally oblong, trapezoidal and/or rectangular shape.

In the example of FIGS. 3 and 4, but not limited to, the through housings 222 are six. These through housings 222 are distributed around axis X in a single annular row of through housings. Alternatively, these through housings 222 can be divided into two or more annular rows of through housings one after the other.

The body 22 may comprise the central orifice 220 for the passage. This central orifice 220 is configured for the passage of the cylindrical portion 210 of the tip 21. The central orifice 220 may be located on the radial wall 226, particularly at the upstream end 221. This central orifice 220 may be aligned substantially at the level of the axis X. The central orifice 220 may be tapped to facilitate attachment of the cylindrical portion 210. The central orifice 220 may have a diameter of at least approximately 10 mm.

The body 22 comprises parts 23 made of elastically deformable material. The parts 23 and the tip 21 can be made from the same elastically deformable material. These parts 23 are located in the through housings 222. Each part 23 can have a maximum second thickness E₂₃ of between 2 mm and 3 mm. This second thickness E₂₃ is measured in a direction perpendicular to the internal surface 22a of the body 22 (or in other words in a plane inclined to the axis X). The second thickness E₂₃ may be greater than the first thickness E₂₂ of the body 22.

Each part 23 may have a first total length L₂₃, for example measured substantially along a direction parallel to the internal surface 22a of the body 22 (or otherwise along a plane inclined to the axis X).

The parts 23 may be between three and ten. The parts 23 can be distributed in one or more annular rows of parts.

In the example shown in FIGS. 3 and 4, but not limited to these, there are six parts 23. These parts 23 are distributed around the axis X in a single annular row of parts. Alternatively, these parts 23 can be divided into two or more annular rows of parts one after the other.

One of the characteristics of the invention is that each of the parts made of elastically deformable material 23 comprises at least one peripheral rim 230 for retaining this part 23 in the corresponding through-housing 222. This peripheral rim 230 rests on the internal surface 22a of the body 22. Advantageously, the peripheral rim 230 can rest directly on the inner surface 22a, preferably without adhesive between this peripheral rim 230 and the internal surface 22a.

As illustrated in FIGS. 4, 6 and 7, each of the parts 23 may comprise a single peripheral rim 230 which extends around the entire perimeter of the part 23.

The peripheral rim 230 may have a third thickness E₂₃₀ measured, for example, in a direction perpendicular to the internal surface 22a or external surface 22b of the part 23 in question.

According to another characteristic of the invention, each of the parts 23 may comprise a pad 236. In the example shown, each pad 236 may project outwards from the peripheral rim 230.

The pad 236 may comprise an internal surface 236a and an external surface 236b opposite this internal surface 236a. The internal surface 236a and external surface 236b of the pad 236 may be substantially parallel to the internal surface 22a and external surface 22b of the body 22, respectively. The external surface 236a can be aligned with the external surface 22b of the body 22 to ensure aerodynamic continuity. The external surface 236b of the pad 236 may correspond substantially and generally to an external surface of the part 23 in question.

The pad 236 can occupy the entire volume of the through housing 222. To achieve this, the pad 236 may have a complementary shape to that of the corresponding through housing 222. For example, the pad 236 is generally oblong, trapezoidal and/or rectangular in shape.

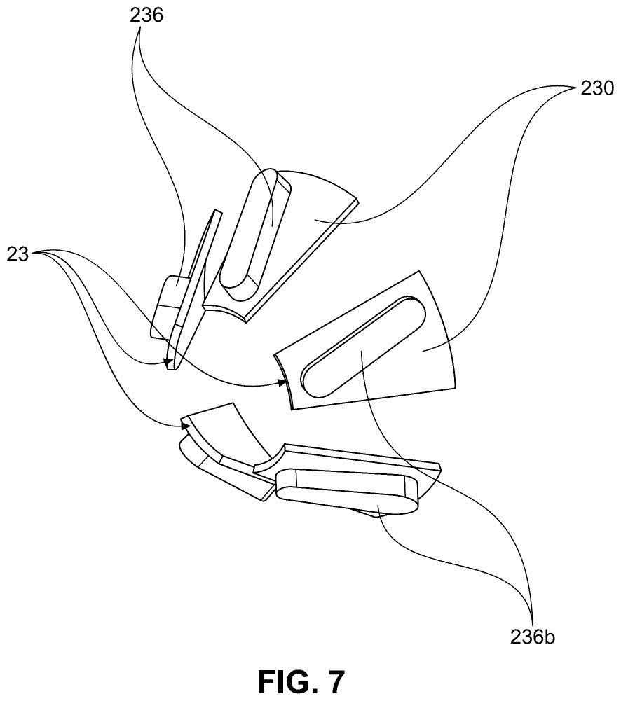

FIGS. 3, 4 and 6 show trapezoidal pads 236. Alternatively, the pads 236 can be oblong, as shown in FIG. 7.

The pad 236 may have a fourth thickness E₂₃₆, for example measured in a direction perpendicular to the external surface 236b of the part 23 in question (or in other words in a direction perpendicular to the internal surface 22a or external surface 22b of the body 22).

The pad 236 may have a second length L₂₃₆ measured in a direction parallel to the external surface 236b (or the internal surface 22a of the body 22). This second length L₂₃₆ can be between 50% and 90% of the total first length L₂₃ of the corresponding part 23. In the example shown in FIG. 4, the second length L₂₃₆ is approximately 75% of the first length L₂₃.

The third thickness E₂₃₀ of the peripheral rim 230 may be equal to the difference between the fourth thickness E₂₃₆ of the pad 236 (or the maximum second thickness E₂₃ of the part 23 in question) and the first thickness E₂₂ of the body 22. Each of these thicknesses E₂₂, E₂₃₀, E₂₃₆ can be measured in a direction perpendicular to the external surface 236b of the part 23 in question (or said another way along a direction perpendicular to the internal surface 22a of the body 22). For example, the third thickness E₂₃₀ of the peripheral rim 230 may be between 2 mm and 3 mm.

1. An inlet cone for an aircraft turbine engine, said inlet cone being configured to be driven in rotation about an axis (X) and comprising a body of frustoconical shape and a tip made of elastically deformable material fixed to an end of smaller diameter of said body,
the body comprising through-housings distributed around the axis (X) and parts made of elastically deformable material located in said through-housings,
wherein each of the parts made of elastically deformable material comprises at least one peripheral rim for retaining said part in the corresponding through housing, said at least one peripheral rim bearing on an internal surface of said body.

2. The inlet cone according to claim 1, wherein each of the parts made of elastically deformable material comprises a single peripheral rim which extends around the entire periphery of the part in question.

3. The inlet cone according to claim 1, wherein that each of the parts of elastically deformable material comprises a pad which occupies the entire volume of said through housing and which comprises an external surface aligned with an external surface of said body.

4. The inlet cone according to claim 3, wherein said pad is generally at least one of oblong, trapezoidal and rectangular in shape.

5. The inlet cone according to claim 3 wherein said pad extends over a length (L₂₃₆) of between 50% and 90% relative to a total length (L₂₃) of said corresponding part made of elastically deformable material, the lengths (L₂₃, L₂₃₆) being measured substantially in a direction parallel to the external surface of the pad of the part in question.

6. The inlet cone according to claim 3, wherein said at least one peripheral rim has a thickness (E₂₃₀) which is equal to the difference between a thickness (E₂₃₆) of the pad and a thickness (E₂₂) of the body, each of these thicknesses (E₂₂, E₂₃₀, E₂₃₆) being measured in a direction perpendicular to the external surface of the part in question.

7. The inlet cone according to claim 1, wherein each elastically deformable part has a maximum thickness (E₂₃) of between 2 mm and 3 mm, the thickness (E₂₃) being measured in a direction perpendicular to the internal surface of the body.

8. The inlet cone according to claim 1, wherein the body also comprises a central orifice for the passage of a cylindrical portion of said tip.

9. The inlet cone according to claim 1, wherein said through housings and said parts made of elastically deformable material are three to ten in number, preferably said through housings and said parts made of elastically deformable material are six in number.

10. The inlet cone according to claim 1, wherein said through housings and said parts made of elastically deformable material are distributed in at least one annular row, respectively, of through housings and parts made of elastically deformable material.

11. The inlet cone according to claim 1, wherein the tip is in single part.

12. The inlet cone according to claim 1, wherein the body is made of a metallic or composite material.

13. The inlet cone according to claim 1, wherein said at least one peripheral rim rests directly on the internal surface of said body.

14. An aircraft turbine engine comprising an inlet cone according to claim 1.
